(19) United States
(12) Patent Application Publication
(10) Pub. No.: US 2016/0191358 A1
(43) Pub. Date: Jun. 30, 2016

(54) TESTING METHOD FOR A SMART WRISTBAND AND TESTING SYSTEM THEREOF

(71) Applicant: Huizhou TCL Mobile Communication Co., Ltd, Huizhou City, Guangdong (CN)

(72) Inventors: Yin GUAN, Huizhou City, Guangdong (CN); Min YANG, Huizhou City, Guangdong (CN)

(73) Assignee: HUIZHOU TCL MOBILE COMMUNICATION CO., LTD, Huizhou City, Guangdong (CN)

(21) Appl. No.: 14/647,723

(22) PCT Filed: May 22, 2014
(86) PCT No.: PCT/CN2014/078111

§ 371 Date: Oct. 28, 2015

(30) Foreign Application Priority Data
Mar. 20, 2014 (CN) 201410105665.9

(51) Int. Cl. H04L 12/26; H04W 68/00; H04W 4/00; H04W 76/04; H04B 1/3827; H04W 76/02

(52) U.S. Cl. CPC H04L 43/0811; H04B 1/385; H04W 76/023; H04W 4/008; H04W 76/046; H04W 68/005

(57) ABSTRACT

A testing method for a smart wristband and a testing system thereof are provided. The testing method includes the following steps of: presetting the system software before the test to put the Bluetooth function of the smart wristband into a sleep state after the system software is installed; electrically connecting the smart wristband under test to a testing apparatus during the test so that the Bluetooth function of the smart wristband is activated; and accomplishing pairing of the smart wristband with the testing apparatus to test functions of the smart wristband. In this way, the present disclosure can ensure pairing connection of a designated smart wristband under test with the testing apparatus during the test with a high efficiency and at a low cost.

### FIELD OF THE INVENTION

The present disclosure relates to the technical field of terminal testing, and more particularly, to a testing method for a smart wristband and a testing system thereof.

### BACKGROUND OF THE INVENTION

As a new kind of wearable smart mobile terminals, smart wristbands have gradually become great favorites in the global consumer electronics market following the smartphones and the tablet computers. Therefore, testing of various functions of the smart wristbands becomes essential.

Currently, in consideration of such factors as virtual identity electronic identification (ID) security and waterproofness, smart wristbands are not provided with a physical side key for controlling activation/deactivation of the Bluetooth function. Meanwhile, because most of the smart wristbands adopt the BT 4.0 LE mode and are preemptive in terms of pairing, they actively pair with surrounding apparatuses whose Bluetooth function has been activated once the smart wristbands under test are powered on during the test.

Therefore, during specific testing phases in specific scenarios, e.g., during commissioning and R&D testing in laboratories, a smart wristband under test can be tested normally by bringing the smart wristband alone to nearby a testing apparatus and moving other smart wristbands away. However, during mass production in production lines of factories, the Bluetooth function of a large batch of smart wristbands will be activated automatically once the smart wristbands are assembled and batteries thereof are soldered in place, so it is impossible to ensure pairing of a designated smart wristband under test with the testing apparatus.

### SUMMARY OF THE INVENTION

Accordingly, a technical problem to be solved by the present disclosure is to provide a testing method for a smart, wristband and a testing system thereof, which can ensure pairing of a designated smart wristband under test with the testing apparatus during the test with a high efficiency and at a low cost.

To solve the aforesaid technical problem, a technical solution adopted in the present disclosure is as follows: a testing method for a smart wristband is provided, and the method comprises the following steps of: presetting the system software to put the Bluetooth function of the smart wristband, as being powered by a built-in battery, into a sleep state after the system software is installed; electrically connecting the smart wristband under test to a testing apparatus during the test so that the Bluetooth function of the smart wristband is activated as being powered by the testing apparatus; accomplishing pairing of the smart wristband with the testing apparatus, and meanwhi le, playing a prompting ringtone to prompt that the pairing has been completed; and testing functions of the smart wristband.

Preferably, the testing method further comprises the following steps of: setting, before the test, flag bits for identifying whether the pairing has been completed, wherein a first flag bit is set for the smart wristband and a second flag bit is set for the testing apparatus; and setting the second flag bit for the smart wristband after the pairing has been completed.

Preferably, the smart wristband is provided with a rest button, and the testing method further comprises the following step of: if the smart wristband runs out of power during the test, then charging the smart wristband and, meanwhile, long-pressing the reset button to put the Bluetooth function of the smart wristband into the sleep state again.

Preferably, the smart wristband and the testing apparatus are fixed in a shielding box, and the testing apparatus is a smartphone, a computer or a terminal having the Bluetooth function.

To solve the aforesaid technical problem, another technical solution adopted in the present disclosure is as follows: a testing method for a smart wristband is provided, and the method comprises the following steps of: presetting, before the test, the system software to put the Bluetooth function of the smart wristband into a sleep state after the system software is installed; carrying out electrical connection operations on the smart wristband under test during the test so that the Bluetooth function of the smart wristband is activated; and accomplishing pairing of the smart wristband with a testing apparatus to test functions of the smart wristband.

Preferably, the step of carrying out electrical connection operations on the smart wristband under test during the test comprises the following step of: electrically connecting the smart wristband under test to the testing apparatus during the test, and electrically disconnecting the smart wristband from the testing apparatus after the Bluetooth function is activated.

Preferably, the testing method further comprises the following step at the same time as the step of accomplishing pairing of the smart wristband with the testing apparatus: playing a prompting ringtone to prompt that the pairing has been completed.

Preferably, the testing method further comprises the following steps of: setting, before the test, flag bits for identifying whether the pairing has been completed, wherein a first flag bit is set for the smart wristband and a second flag bit is set for the testing apparatus; and setting the second flag bit for the smart wristband after the pairing has been completed.

Preferably, the smart wristband is provided with a rest button, and the testing method further comprises the following step of: if the smart wristband runs out of power during the test, then charging the smart wristband and, meanwhile, long-pressing the reset button to put the Bluetooth function of the smart wristband into the sleep state again.

Preferably, the smart wristband and the testing apparatus are fixed in a shielding box, and the testing apparatus is a smartphone, a computer or a terminal having the Bluetooth function.

To solve the aforesaid technical problem, yet another technical solution adopted in the present disclosure is as follows: a testing system for a smart wristband is provided, and the testing system comprises a shielding box as well as a positioning mechanism and power pins disposed within the shielding box, wherein: the positioning mechanism is adapted to fix a testing apparatus and the smart wristband under test to specified positions in the shielding box before the test, and the Bluetooth function of the smart wristband is put into a sleep state through presetting of system software installed; and the power pins are adapted to carry out electrical connection operations on the smart wristband under test during the test so that the Bluetooth function of the smart wristband is activated to complete pairing between the smart wristband and the testing apparatus and to test functions of the smart wristband.

Preferably, the power pins are adapted to electrically connect the smart wristband under test to the testing apparatus during the test and electrically disconnect the smart, wristband from the testing apparatus after the Bluetooth function is activated.

Preferably, the testing system further comprises a loud speaker and an earphone jack, wherein the loud speaker is adapted to play a ringtone for prompting that the pairing has been completed, and the earphone jack is adapted to receive an earphone therein so that the prompting ringtone is played via the earphone to prompt that the pairing has been completed.

Preferably, the testing apparatus is a smart-phone, a computer or a terminal having the Bluetooth function, and the smart wristband is provided with a reset button, which is adapted to put the Bluetooth function of the smart wristband into the sleep state again through long-pressing of the reset button if the smart wristband runs out of power during the test and is being charged.

As compared to the prior art, the present disclosure has the following benefits: the system software to be installed in the smart wristband is set before the test to put the Bluetooth function of the smart wristband into a sleep state so that the smart wristband cannot be paired with other terminals having the Bluetooth function; and electrical connection operations are carried out on the smart wristband under test during the test so that the Bluetooth function of the smart wristband is activated to accomplish pairing with the testing apparatus and perform subsequent functional testing. Thus, the present disclosure can ensure pairing of a designated smart wristband under test with the testing apparatus during the test with a high efficiency and at a low cost.

### BRIEF DESCRIPTION OF THE DRAWINGS

FIG. 1 is a flowchart diagram of a test method for a smart wristband according to a preferred embodiment of the present disclosure.

### DETAILED DESCRIPTION OF THE INVENTION

To make the objectives, technical solutions and technical effects of the present disclosure clearer, a detailed description will be further made on embodiments of the present disclosure with reference to the attach drawings.

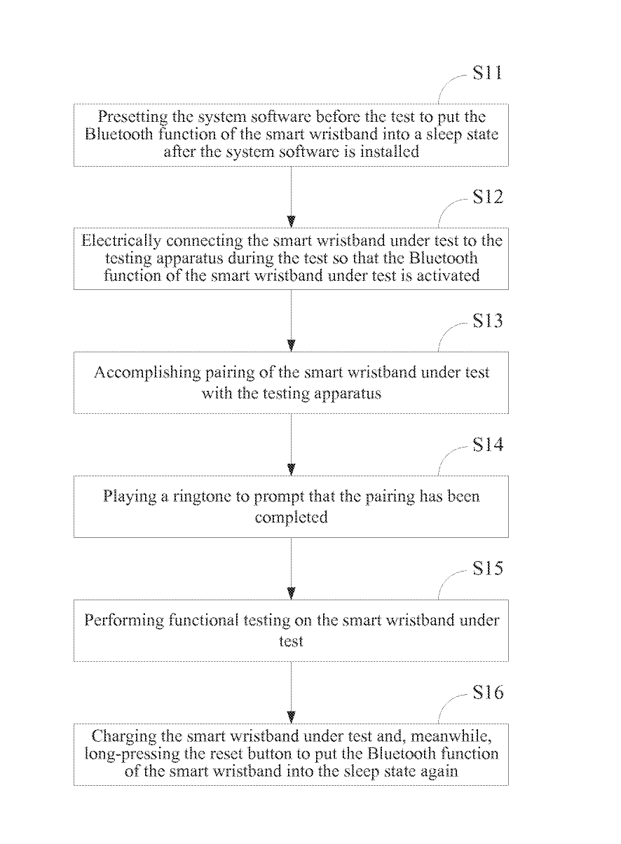

FIG. 1 is a flowchart diagram of a test method for a smart wristband according to a preferred embodiment of the present disclosure. The testing method of the present disclosure is based on a testing system of the smart wristband, and the testing system comprises a shielding box as well as a positioning mechanism and power pins disposed within the shielding box. The shielding box is adapted to define a testing environment to ensure that there is no interference from other testing signals during the test. The positioning mechanism is adapted to fix the testing apparatus and the smart wristband under test to specified positions in the shielding box before the test so as to ensure that positions of the testing apparatus and the smart wristband under test relative to each other remain fixed during the testing. The power pins are adapted to carry out electrical connection operations on the smart wristband during the test so that the Bluetooth function of the smart wristband is activated. It shall be understood that, the testing system of the smart wristband disclosed in the present disclosure may also be implemented in other ways.

Bluetooth is the only communication interface means of the smart wristband of the present disclosure, and all the functional tests on the smart wristband are based on a Bluetooth connection created between the smart wristband and the testing apparatus. A smartphone is taken as an example of the testing apparatus mentioned throughout the present disclosure. Of course, the testing apparatus is not limited to a smartphone but may be any terminal having the Bluetooth function, including a personal computer (PC), a Bluetooth instrument, a notebook computer, a personal digital assistant (PDA), or a tablet computer, etc.

Referring to FIG. 1, the testing method for the smart wristband of this embodiment comprises the following steps:

Step S11: presetting the system software before the test to put the Bluetooth function of the smart wristband into a sleep state after the system software is installed.

For the smart wristband, in designing of the system software that is to be installed and operated on the smart wristband, the system software is programmed to ensure that, once being downloaded or installed, the system software automatically controls the smart wristband to put the Bluetooth function of the smart wristband into a sleep state (i.e., deactivated).

Similarly, for the smart wristband, an ROM (Read Only Memory) of the smart wristband is empty before the system software is downloaded, and once it is detected that the ROM is not empty (i.e., the system software has been downloaded or installed), the smart wristband automatically deactivates the Bluetooth function, i.e., puts the Bluetooth function thereof into a sleep state.

Preferably, flag bits are set in the smart wristband through the use of system software before the test so as to identify whether the pairing connection between the smart wristband and the testing apparatus has been completed in subsequent testing, where a first flag bit represents that the pairing connection therebetween is not completed or fails, and a second flag bit represents that the pairing connection therebetween has been completed. Preferably, the first flag bit is set to be 0 and the second flag bit is set to be 1 in this embodiment. Then, the smart wristband has the first flag bit 0 set therein and the testing apparatus has the second flag bit 1 set therein by default before the test. It shall be appreciated that, the first flag bit and the second flag bit may also be expressed as corresponding labels (e.g., TRUE and FALSE) rather than specific values.

Step S12: electrically connecting the smart wristband under test to the testing apparatus during the test so that the Bluetooth function of the smart wristband under test is activated.

After the smart wristband under test and the testing apparatus have been fixed by the positioning mechanism to specified positions in the shielding box, electrical connection operations can be carried out on the smart wristband under test via the power pins to activate the Bluetooth function of the smart wristband and keep the Bluetooth function of the smart wristband being activated during the whole testing process. Then, the electrical connection between the smart wristband and the testing apparatus via the power pins is disconnected.

The power pins preferably electrically connect the smart wristband under test to the testing apparatus during the test in this embodiment. Of course, the power pins may electrically connect the smart wristband to other power sources in other embodiments, and no limitation is made thereto in the present disclosure.

Step S13: accomplishing pairing connection of the smart wristband under test with the testing apparatus.

After the Bluetooth function of the smart wristband under test is activated, the Bluetooth function of the testing apparatus is also activated. In the shielding box, only the smart wristband under test and the testing apparatus have the Bluetooth function, so it can be ensured that the specified smart wristband under test and the test apparatus are connected in one-to-one correspondence via Bluetooth during the test, i.e., that the primary objective of the present disclosure is achieved.

Additionally, in terms of the flag bit that is set in the step S11 to identify whether the pairing connection between the smart wristband and the testing apparatus is completed, the first flag bit 0 in the smart wristband is changed into the second flag bit 1 when the pairing connection is completed in this step S13, and this is preferably displayed to the testing personnel via the screen of the testing apparatus so that the testing personnel can click on the testing apparatus to confirm that the pairing connection between the testing apparatus and the smart wristband has been completed.

Preferably, the testing method of this embodiment further comprises step S14: playing a ringtone to prompt that the pairing connection has been completed. Specifically, the testing system on which the test method is based further comprises a loud speaker and an earphone jack, wherein the loud speaker is adapted to play a ringtone for prompting the testing personnel that the pairing connection has been completed, and the earphone jack is adapted to receive an earphone therein so that the prompting ringtone is played via the earphone to prompt the testing personnel that the pairing connection has been completed and the subsequent functional testing can be performed.

Step S15: performing functional testing on the smart wristband under test. Data instructions are transmitted via the Bluetooth connection between the testing apparatus and the smart wristband to perform functional testing that includes at least one of Bluetooth power testing, writing of the mainboard serial number, charging testing and motor vibration controlling.

In consideration of cases where the smart wristband suffers from a crash fault or has a low power level or even runs out of power during the functional testing, the smart wristband may be provided with a reset button. In this case, the testing method of the present disclosure further comprises step S16: charging the smart wristband under test and, meanwhile, long-pressing the reset button to put the Bluetooth function of the smart wristband into the sleep state again. This step is mainly used to ensure that the smart wristband will not establish a Bluetooth connection with other terminals when the smart wristband is taken out of the shielding box and is being charged. Later, the aforesaid step S12 can be executed to continue the test.

According to the above descriptions, the system software to be installed in the smart wristband is preset before the test to put the Bluetooth function of the smart wristband into a sleep state so that the smart wristband cannot be paired connection with other terminals having the Bluetooth function; and electrical connection operations are carried out on the smart wristband under test during the test so that the Bluetooth function of the smart wristband is activated to accomplish pairing with the testing apparatus and perform subsequent functional testing. Thus, the present disclosure can ensure pairing of a designated smart wristband under test with the testing apparatus during the test with a high efficiency and at a low cost.

What described above are only the embodiments of the present disclosure, but are not intended to limit the scope of the present disclosure. Any equivalent structures or equivalent process flow modifications that are made according to the specification and the attached drawings of the present disclosure, or any direct or indirect applications of the present disclosure in other related technical fields shall all be covered within the scope of the present disclosure.

1. A testing method for a smart wristband, the smart wristband comprising system software and having Bluetooth function, the testing method comprising the following steps of:
presetting the system software to put the Bluetooth function of the smart wristband into a sleep state;
electrically connecting the smart wristband under test;
accomplishing pairing connection of the smart wristband with the testing apparatus, and meanwhile, playing a prompting ringtone to prompt that the pairing connection has been completed; and
testing functions of the smart wristband.

2. The testing method of claim 1, further comprising the following steps of:
setting, before the test, flag bits for identifying whether the pairing connection has been completed, wherein a first flag bit is set for the smart wristband and a second flag bit is set for the testing apparatus; and
setting the second flag bit for the smart wristband after the pairing connection has been completed.

3. The testing method of claim 1, wherein the smart wristband is provided with a rest button, and the testing method further comprises the following step of:
when the smart wristband runs out of power during the test, then charging the smart wristband and, meanwhile, long-pressing the reset button to put the Bluetooth function of the smart wristband into the sleep state again.

4-10. (canceled)

11. A testing system for a smart wristband, comprising:
a shielding box;
a positioning mechanism disposed within the shielding box, and configured to fix a testing apparatus and the smart wristband under test to specified positions in the shielding box before the test, and Bluetooth function of the smart wristband is put into a sleep state through presetting of system software installed; and
power pins disposed within the shielding box,
and configured to carry out electrical connection operations on the smart wristband under test during the test so that the Bluetooth function of the smart wristband is activated to complete pairing connection between the smart wristband and the testing apparatus and to test functions of the smart wristband.

12. The testing system of claim 11, wherein the power pins are adapted to electrically connect the smart wristband under test to the testing apparatus during the test and electrically disconnect the smart wristband from the testing apparatus after the Bluetooth function is activated.

13. The testing system of claim 12, further comprising a loud speaker and an earphone jack, wherein the loud speaker is adapted to play a ringtone tor prompting that the pairing connection has been completed, and the earphone jack is adapted to receive an earphone therein so that the prompting ringtone is played via the earphone to prompt that the pairing connection has been completed.

14. The testing system of claim 12, wherein the testing apparatus is a smartphone, a computer or a terminal having the Bluetooth function, and the smart wristband is provided with a reset button, which is adapted to put the Bluetooth function of the smart wristband into the sleep state again through long-pressing of the reset button when the smart wristband runs out of power during the test and is being charged.

15. The testing method of claim 1, wherein the electrically connecting the smart wristband under test comprises electrically connecting the smart wristband under test to a testing apparatus, and electrically disconnecting the smart wristband from the testing apparatus after the Bluetooth function is activated.

16. The testing method of claim 15, wherein the Bluetooth function of the smart wristband is activated as being powered by the testing apparatus when the smart wristband under test is electrically connected to the testing apparatus.

17. The testing method of claim 15, wherein the testing apparatus has Bluetooth function, after the Bluetooth function of the smart wristband under test is activated, the Bluetooth function of the testing apparatus is also activated.

18. The testing method of claim 17, wherein the smart wristband and the testing apparatus are fixed in a shielding box, in the shielding box, only the smart wristband under test and the testing apparatus have the Bluetooth function so that the smart wristband under test and the test apparatus are connected in one-to-one correspondence via Bluetooth during test.

19. The testing method of claim 15, wherein the smart wristband and the testing apparatus are fixed in a shielding box, and the testing apparatus is a smartphone, a computer or a terminal having the Bluetooth function.

20. The testing method of claim 1, wherein the smart wristband comprises an ROM (Read Only Memory), the ROM is empty before the system software is downloaded, and once it is detected that the ROM is not empty, the smart wristband automatically deactivates the Bluetooth function.

21. The testing method of claim 2, wherein the first flag bit represents that the pairing connection between the smart wristband and the testing apparatus is not completed or falls, and the second flag bit represents that the pairing connection between the smart wristband and the testing apparatus has been completed.
